(19) United States
(12) Patent Application Publication
(10) Pub. No.: US 2018/0054770 A1
(43) Pub. Date: Feb. 22, 2018

(54) CALL TERMINATION TO A NON-3GPP ACCESS DOMAIN

(71) Applicant: Hewlett Packard Enterprise Development LP, Houston, TX (US)

(72) Inventors: Anders H. Askerup, Omaha, NE (US); Lee Barton Valerius, Plano, TX (US)

(21) Appl. No.: 15/239,441

(22) Filed: Aug. 17, 2016

(51) Int. Cl. H04W 40/02

(52) U.S. Cl. CPC H04W 40/02; H04W 12/08

(57) ABSTRACT

Examples herein request activity of a wireless device in a non-3GPP access domain by an authorization server. The authorization server receives information regarding the activity of the wireless device in the non-3GPP access domain and based on the information, determines if the non-3GPP access domain is a current domain of the wireless device. In response to the determination that the non-3GPP access domain is the current domain, terminate a phone call to the wireless device in the non-3GPP access domain.

### BACKGROUND

Wireless communication networks have increased in popularity with the advent of wireless devices, such as smartphones, mobile devices, etc. Such wireless communication networks provide both data and voice communications. These two types of communications have been separate, but with the arrival of voice-over Internet Protocol (VoIP) technologies, voice communication has merged with data communication.

### BRIEF DESCRIPTION OF THE DRAWINGS

In the accompanying drawings, like numerals refer to like components or blocks. The following detailed description references the drawings, wherein:

FIG. 1 is a block diagram of an example telecommunications system including a wireless device in accordance with the present disclosure;

FIG. 2 is a diagram of example communications between various network components for terminating a phone call to a wireless device in accordance with the present disclosure;

FIG. 3 is a flowchart of an example method to query activity of a wireless device based on an initiation of a call termination to the wireless device in accordance with the present disclosure;

FIG. 4 is a block diagram of an example computing device with a processing resource to execute instructions in a machine-readable storage medium for terminating a phone call to a wireless device in accordance with the present disclosure; and

FIG. 5 is a block diagram of an example computing device with a processing resource to execute instructions in a machine-readable storage medium for identifying a current domain of a wireless device based on time information and in response, terminating a phone to the wireless device in accordance with the present disclosure.

### DETAILED DESCRIPTION

Existing mobile communication network technologies may not currently support seamless integration with wide local area networks (WLANs). For example, when a user of a smartphone is called using the respective phone number, the access domain to which the smartphone is currently connected (i.e, attached) is determined so the phone call can terminate (i.e., connect to) the user's smartphone. The terminology “access domain” refers to the protocol and/or infrastructure by which a user's device communicates. The access domain may include a type of third generation partnership (3GPP) access domains such as 4G-type domain supported by a network device known as a mobile management entity (MME) or a 2G/3G-type domain that may be supported by a network device a general packet radio service (GPRS) support node (SGSN). When the user moves within one of these access domains, the smartphone registers with the respective network device (e.g., MME, SGSN) to attach to the corresponding 3GPP access domain (e.g., 4G, 3G, 2G).

The advent of wireless local-area network (WLAN) technologies such as Wi-Fi, voice over Internet Protocol (VoIP), voice-over WLAN (VoWLAN), has produced a cost, quality, and efficiency advantage over the above-mentioned 3GPP access domains. As such, the WLAN technologies have become the preferred method for voice communications.

In the VoLAN technology, a user's device attaches to a non-3GPP access domain by registering with an authentication, authorization, and account (AAA) server. Such AAA registration occurs outside of the auspices of MME and SGSN attachment. This means that a terminating phone call to the user's device attached to a non-3GPP access domain is difficult to accomplish. Accordingly, seamless integration between mobile communication networks using a 4G or 2G/3G protocol and WLANs connected to the network may be difficult to achieve in practice.

Accordingly, the present disclosure provides a mechanism to termination a phone call to the user's device attached to the non-3GPP access domain. Terminating phone calls to device(s) attached to non-3GPP access domains seamlessly integrates both mobile communication networks and WLAN technologies. Integrating these technologies, optimizes a number of phone call terminations to achieve a high level of voice quality while also providing a lower cost.

The present disclosure identifies a current domain for a wireless device and in response to the non-3GPP domain as the current domain, the phone call may terminate to the wireless device in the non-3GPP domain. In this example, the non-3GPP domain is the preferred domain due to cost, voice quality, and efficiency. Thus, identifying the preferred domain allows the selection of that preferred domain for the phone call termination to the wireless device.

The following detailed description refers to the accompanied figures. Wherever possible, the same reference numbers are used in the figures and the following description to refer to the same or similar parts. It is to be expressly understood, however, that the figures are for the purpose of illustration and description only. While several examples are described throughout, modification, adaptions, and other implementations are possible. Accordingly, the following detailed description is not meant to limit the disclosed examples, rather it is meant to provide proper scope of the disclosed examples and may be defined by the appended claims.

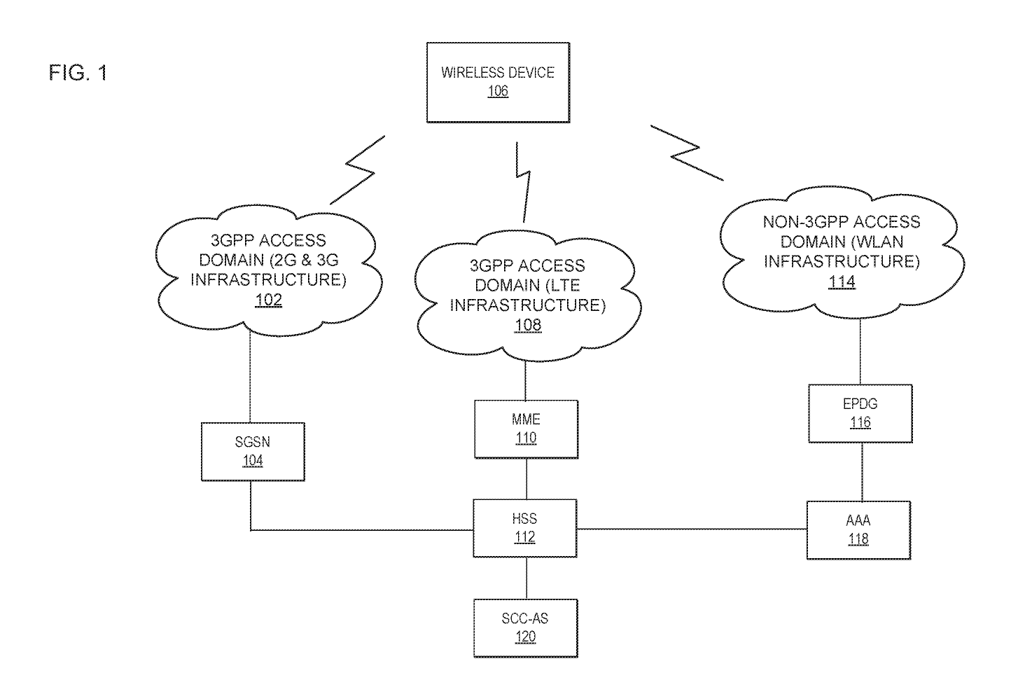

FIG. 1 illustrates an example telecommunication system including wireless communication networks and WLAN infrastructure 114 in which wireless device 106 may receive phone calls. Wireless device 106 may receive phone calls when attached to a 3GPP access domain, such as a 4G-type domain or 2G/3G-type domain or non-3GPP access domain, such as a WLAN-type domain. The telecommunication system includes SGSN 104, MME, 110, home subscriber server (HSS) 112, AAA server 118, and enhanced packet data gateway (ePDG) 116. The system further includes 2G/3G wireless communication infrastructure 102, 4G LTE infrastructure 108, and WLAN infrastructure 114. The system includes wireless device(s) 106 and a service centralization and continuity application server (SCC-AS) 120. The communication depicted in FIG. 1 among the SGSN 104, HSS 112, MME 110, ePDG 116, AAA server 118, infrastructures 102, 108, and 114, and SCC-AS 120 specifically signals communication for maintaining and determining registration of wireless device(s) 106 with the SGSN 104, MME 110, and ePDG 116 as managed by HSS 112.

Wireless device(s) 106 may attach to these infrastructures 102, 108, and 114 via SGSN 104, MME 110, and ePDG 116 to receive communication services including voice communication. As such, these components 104, 110, and 116 signal to terminate the phone call (i.e., receive the phone call). The wireless device(s) 106 may have attached to multiple infrastructures 102, 108, and 114; however the WLAN infrastructure may be the preferred infrastructure 114 for attachment due to cost, voice quality, and efficiency. Accordingly, if the wireless device(s) 106 is attached to one of the 3GPP access domains (e.g., 2G/3G infrastructure 102 and/or LTE infrastructure 108) and the WLAN infrastructure 114, the WLAN infrastructure 114 would be the preferred infrastructure in which to terminate the phone call to wireless device(s) 106. HSS 112 communicates with SCC-AS 120, and AAA server 118 to terminate the phone call within the WLAN infrastructure 114.

HSS 112 communicates over wired communication lines with SGSN 104, MME 110, AAA server 118, and SCC-AS 120. SGSN 104 communicates over a wired communication line with 2G/3G infrastructure 102 that supports a 2G/3G-type 3GPP access domain. MME 110 communicates over a wired communication line with LTE infrastructure 108 that supports a 4G-type 3GPP access domain. AAA server 118 communicates to ePDG 116 which also communicates over a wired communication line with WLAN infrastructure 114 that supports a WLAN-type non-3GPP access domain, such as VoWLAN in the case of voice communication, such as phone calls. Wireless device(s) 106 communicate wirelessly with infrastructures 102, 108, and 114.

HSS 112 is a type of server which maintains registrations of wireless device(s) 106 with SGSN 104, MME 110, and AAA server 118. SGSN 104 is a type of network component or cellular communication device that is compatible with the 2G/3G protocol, while MME 110 is a type of network or cellular communication network device that is compatible with the 4G infrastructure illustrated by LTE infrastructure 108. AAA server 118 is a server which performs authentication, authorization, and accounting functionality of wireless device(s) 106 for WLAN communication, including VoWLAN communication. In this regard, the AAA server 118 authenticates a user's device (e.g, wireless device 106) to verify and identify the user's device to communicate over WLAN, such as participating in VoWLAN voice communication, and performs accounting to the usage of the WLAN infrastructure 114. ePDG 116 is a gateway which communicates with access points in a WLAN infrastructure 114 and establishes a secure tunnel to encrypt data in the form of packets between wireless device(s) 106 and itself. ePDG 116 communicates with AAA server 118 to provide time information such as the last time packets were communicated. SCC-AS 120 is an application server which communicates with HSS 112 and generates the request to determine which domain(s) wireless network 106 is attached, so that the SCC-AS 120 can appropriately route an incoming call (i.e., terminate the call) to the appropriate wireless device 106. This request may be referred to as a terminating access domain selection (T-ADS) related request. In response to receiving the request, HSS 112 signals to AAA server 118 to query ePDG 116 for activity of the wireless device 106 within WLAN infrastructure 114 to determine if wireless device 106 is currently within WLAN infrastructure 114 to handle packet switching communication. This implementation may be discussed in later figures.

LTE infrastructure 108 includes radio towers, base stations and other components (not illustrated) within which wireless device(s) 106 directly communicate using the LTE protocol, such as VoLTE for voice communication. 2G/3G infrastructure 102 includes radio towers, base stations, and other components (not illustrated) within which wireless device(s) 106 directly communicate using the 2G/3G protocol, including voice communication in a circuit-switched manner. WLAN infrastructure 114 includes access points, routers, and other components (not illustrated) which wireless device(s) 106 directly communicate using an IP protocol, such as VoWLAN, VoWiFi, etc. LTE infrastructure 108 and 2G/3G infrastructure 102 represent various 3GPP access domains while WLAN infrastructure 114 represents a non-3GPP access domain. As such, the term non-3GPP domain may refer to a packet-switching network and as such used interchangeably throughout this document with the term WiFi, WLAN, or IP.

Wireless device(s) 106 represent the user devices and/or equipment within the telecommunications system in FIG. 1. Wireless device(s) 106 may include an electronic device and as such implementations of wireless device(s) 106 may include, by way of example, a wireless mobile device, smartphone, tablet, etc.

HSS 112 maintains various registrations between the 3GPP access domains and the non-3GPP access domain. For example, HSS 112 maintains 2G/3G registration of the wireless device 106 with SGSN 104, LTE registration of wireless device 106 with MME 110, and WLAN registration of wireless device 106 with AAA server 118 or ePDG 116. Registration of wireless device 106 with SGSN 104, MME 110, AAA server 118, and ePDG 116 means that wireless device 106 has moved into a physical location serviced by the respective components 104, 110, 116, and 118. As such, wireless device 106 may register with at least one of the network components to receive communication services in that area. As explained earlier, wireless device 106 may concurrently register in more than one wireless communication area (e.g., 2G/3G, LTE, and WLAN); however, the preferred domain if the wireless device 106 is currently registered, would be WLAN due to the aforementioned reasons.

In response to an initiation of the phone call (i.e., voice communication) to wireless device 106, SCC-AS 120 determines the current registrations of wireless device 106 to terminate the phone call to the wireless device 106. To determine the current registrations of wireless device 106, HSS 112 queries SGSN 104 for attachment of wireless device 106 within the 2G/3G infrastructure 102, MME 110 for attachment of wireless device 106 within LTE infrastructure 108, and AAA 118 for attachment of wireless device 106 within WLAN infrastructure 114. Attachment of the wireless device 106 within the WLAN infrastructure 114 means wireless device 106 is attached to the non-3GPP domain and is able to receive voice communication over VoWLAN. In this implementation, HSS 112 queries respective network component 104, 110, and 118 for the most recent activity of wireless device 106 within each respective domain. In response, the queried network components 104, 110, and 118 transmit time information over the wireless device 106 activity within each respective domain. The HSS 112 analyses the time information to identify the most current domain(s) for wireless device 106. If the time information from the non-3GPP domain is newer than the time information from the 3GPP domain, it means the phone call will be terminated in the non-3GPP domain over the 3GPP domain. In response to the determination the wireless device 106 has attached to only one of the 3GPP domains, then termination of the phone call will be in the 3GPP domain. The communications between networking components 104, 110, 112, 116, 118, and 120 for terminating the phone call to the wireless device 106 within the non-3GPP or 3GPP domain is illustrated in the next figure.

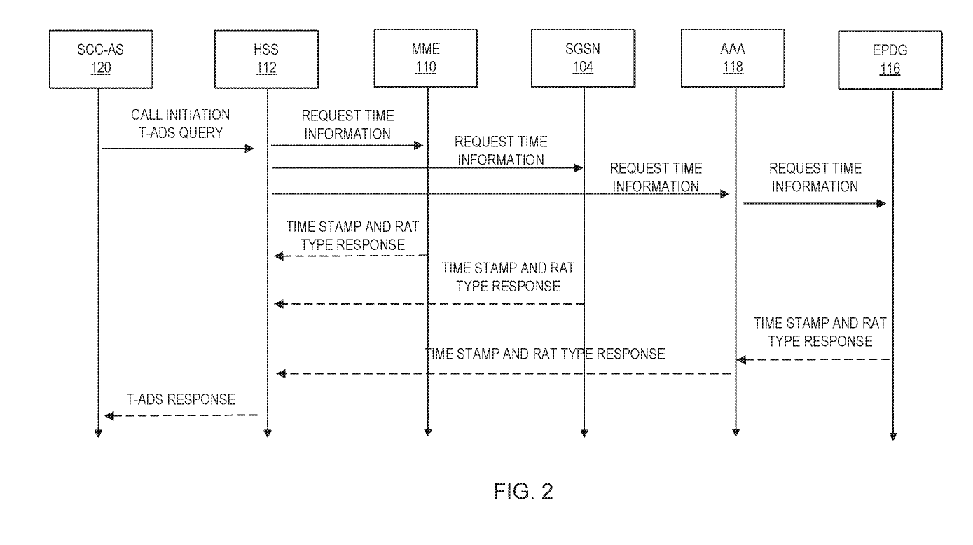

FIG. 2 illustrates an example communication diagram between network components 104, 110, 112, 116, 118, and 120 as illustrated in FIG. 1 for termination of a phone call to a wireless device in a 3GPP domain or non-3GPP domain. In this implementation, the non-3GPP domain is preferred to one of the 3GPP domains.

SCC-AS 120 transmits a terminating access domain (T-ADS) query to HSS 112 based on an initiation of a phone call termination. HSS 112 transmits a request for time information to MME 110, SGSN 104, and AAA server 118 to identify which domains the wireless device is attached. In implementations, HSS 112 communicates to each of these components 110, 104, and 118 using various protocols including, by way of example, diameter protocol, RADIUS protocol, S6a protocol, SWx protocol, SWm protocol, MAP protocol, extensible authentication protocol, etc.

Based on receiving the request for time information from HSS 112, AAA server 118 in turn proceed to query ePDG 116 for time information over the wireless device within the non-3GPP domain. The ePDG 116 receives the request from AAA server 118 for the activity of the wireless device within the non-3GPP domain and may proceed to communicate with access points within the WLAN to identify the activity of the wireless device. The activity may include the time when IP packets were communicated with the WLAN. As such, the ePDG 116 obtains a time stamp of when the IP packets were transmitted within the WLAN by the wireless device and transmits the time stamp as a response to AAA server 118. In this example, the time stamp serves as the time information over the activity of the wireless device in each domain. In addition to the time stamp, ePDG 116 may also transmit a radio access technology (RAT) type. The RAT type represents the radio technology used by the wireless device and may be useful in determining what services and/or content can be sent to the wireless device. The RAT type may include, by way of example, UMTS Terrestrial Radio Access Network (UTRAN), GSM EDGE Radio Access Network (GERAN), Wireless LAN (WLAN), Generic Access Network (GAN), High Speed Packet Access (HSPA).

HSS 112 receives time information over the activity of the wireless device in the non-3GPP domain by the AAA server 118. In another implementation, HSS 112 receives additional time information over the activity of the wireless device in the 3GPP domains from MME 110 and SGSN 104. HSS 112 uses the time information to identify which current domains the wireless device has had the most recent activity. In a further implementation, the non-3GPP domain corresponding to ePDG 116 may be the preferred domain. For example, in response to both the 3GPP domain and the non-3GPP domain as the current domains, the HSS 112 may select based on the time info, the preferred non-3GPP domain as the domain in which to terminate the phone call to the wireless device. Upon determining the current domain in which to terminate the phone call to the wireless device, HSS 112 provides the domain within the T-ADS response to SCC-AS 120. Upon receiving the domain within the T-ADS response, SCC-AS 120 proceeds to terminate the phone call within the specified domain to the wireless device.

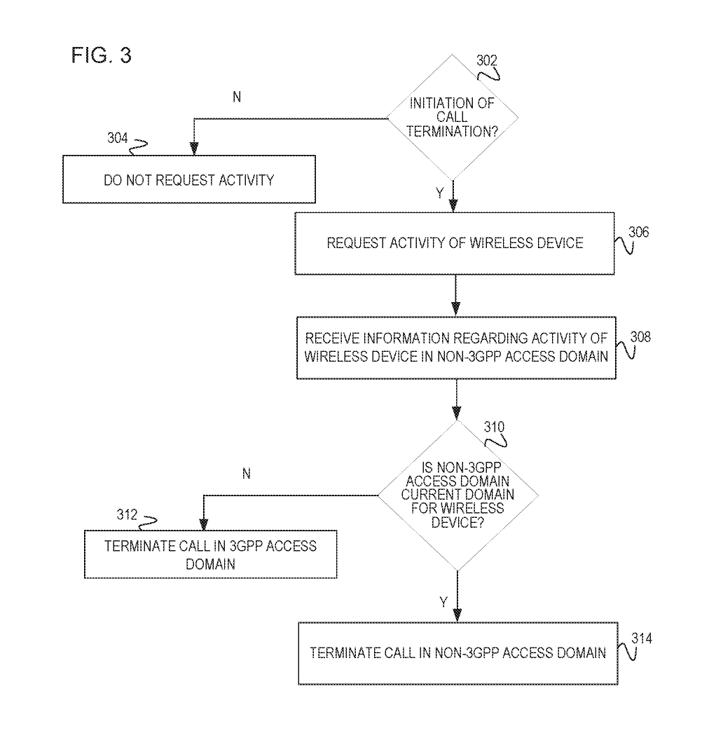

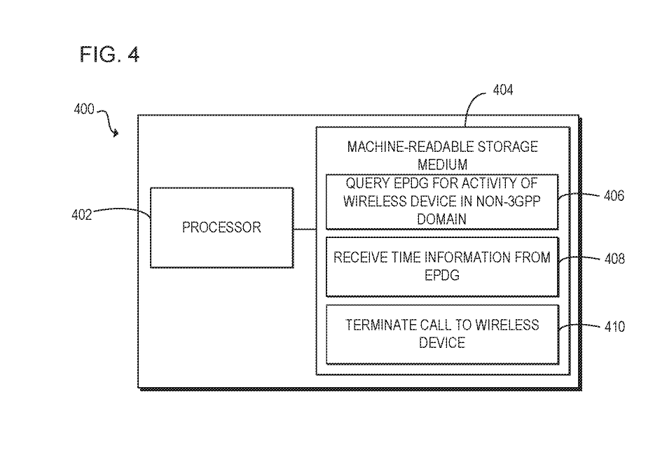

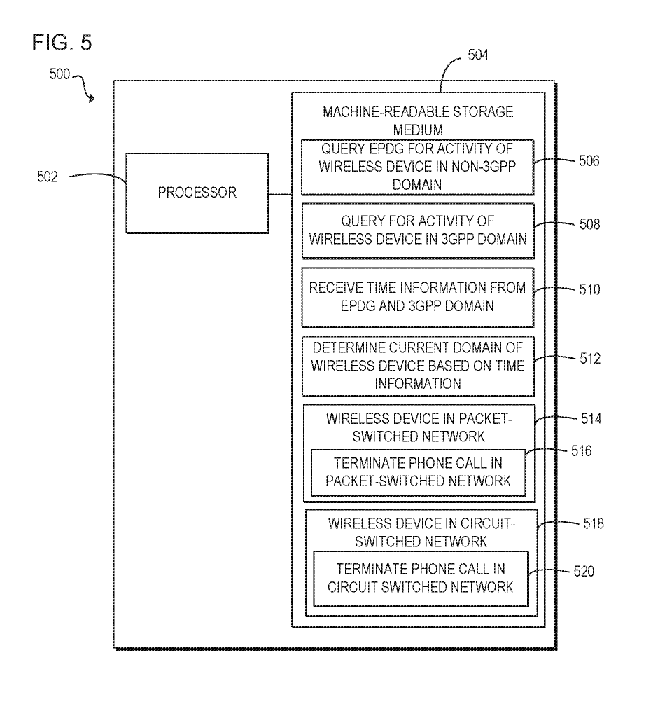

FIG. 3 illustrates a method to terminate a phone call in a non-3GPP access domain. Examples of the non-3GPP access domain including WLAN protocol and/or infrastructure. An AAA server in contact with the WLAN infrastructure may reach out to an ePDG for activity of a specific wireless device within the WLAN. In response, the AAA server receives information corresponding to the activity of the wireless device in the WLAN. Based on the received information, a home subscriber server determines if a current domain of the wireless device is the WLAN. In response to the WLAN being the current domain, the phone call is terminated to the wireless device in the WLAN. In discussing FIG. 3, references may be made to the components in FIG. 1 to provide contextual examples. In one implementation, AAA server 118 as in FIGS. 1-2 executes operations 302-314 to terminate a call in the non-3GPP access domain. Although FIG. 3 is described as implemented by AAA server 118, it may be executable on other suitable hardware components. For example, FIG. 3 may be implemented in the form of executable instructions on a machine-readable storage medium 404 and 504 as in FIGS. 4-5.

At operation 302, in response to the initiation of the call termination to the wireless device, the AAA server requests information over the activity of the wireless device in the WLAN. In one implementation, a service centralization and continuity application server (SCC-AS) transmits a terminating access domain (T-ADS) query to a home subscriber server (HSS). The T-ADS query signals an initiation of the termination of the phone call. In response, the HSS signals to the AAA server the initiation of the termination of the phone call to the wireless device. The AAA server aids in identifying the current domain the wireless device by querying the ePDG over the activity of the wireless device as at operation 306. The ePDG tracks the activity of the wireless device(s) when communicating with a device within the WLAN. The ePDG may store information about the activity of the wireless device(s) within the WLAN to transmit to the AAA server. In another implementation, the HSS may also transmit requests to the SGSN and MME regarding the activity of the wireless device in the 3GPP domain. In a further implementation, if there is no initiation of the terminating phone call, the AAA server does not proceed to communicate with the ePDG over the activity of the wireless device as at operation 304.

At operation 304, in response to the non-initiation of the terminating phone call, the AAA server does not proceed to transmit the request to the ePDG. In this implementation, the AAA server monitors for the initiation of the phone call to the wireless device via the T-ADS query from the SCC-AS. In response to the detection of the non-initiation, the AAA server may continually monitor for the initiation of the terminating phone call to the wireless device.

At operation 306, in response to the initiation of phone call termination to the wireless device, the AAA server transmits the request to the ePDG. As explained earlier, the ePDG stores information related to its communication with the wireless device in the WLAN to track the activity of the wireless device. The request includes data relating to the last time IP packets were being communicated within the WLAN. As such, the ePDG may return time information (e.g, time stamp) of the activity of the wireless device as at operation 308. In one implementation, the AAA server may communicate to the ePDG using a diameter-based SWm interface to request the activity of the wireless device. In this implementation, the SWm interfaced may be used for the WLAN wireless device authentication and may further support tunnel authentication and authorization data. In other implementations, the AAA server may use SWa, STa, SWd, or other type of interface to interact with the wireless device.

At operation 308 in response to the request to the ePDG, the AAA server receives information regarding the activity of the wireless device within the WLAN domain. The information may include a time stamp of when IP packets were last communicated in the WLAN from the wireless device. The information may also include a radio access technology (RAT) type. The time stamp and RAT type may be transmitted to the HSS to determine the current domain of the wireless device.

At operation 310, based on receiving time information regarding the activity of the wireless device in the 3GPP domain and the non-3GPP access domain, the HSS may determine if the non-3GPP access domain is the current domain. In response to the determination that the non-3GPP access domain is the current domain, the HSS may communicate with the SCC-AS for the termination of the phone call to the wireless device in the non-3GPP domain as at operation 314. In another implementation, in response that the non-3GPP domain is not the current domain, this means that the 3GPP domain is the current domain for the wireless device. As such, the HSS communicates with the SCC-AS to terminate the phone call to the wireless device in the 3GPP access domain as at operation 312. In a further implementation, if the HSS determines that the current domain of the wireless device is both the 3GPP and the non-3GPP domain, the time information is used to determine the domain to terminate the phone call.

At operation 312, in response to the determination that the non-3GPP domain is not the current domain, the HSS may communicate with the SCC-AS to terminate the phone call to the wireless device in the 3GPP access domain. Based on the determination that the non-3GPP domain is not the current domain, this may indicate that the 3GPP access domain is the current domain for attachment of the wireless device.

At operation 314, based on the determination that the non-3GPP access domain is the current domain of the wireless device, the phone call is terminated to the wireless device in the non-3GPP access domain.

FIG. 4 is a block diagram of computing device 400 with processing resource 402 to execute instructions 406-410 within a machine-readable storage medium 404. Although the computing device 400 includes processing resource 402 and machine-readable storage medium 404, it may also include other components that would be suitable to one skilled in the art. For example, the computing device 400 may include a controller, memory storage, or other suitable type of component. The computing device 400 is an electronic device with the processing resource 402 capable of executing instructions 406-410 and as such embodiments of the computing device 400 include a networking device, server, switch, router, mobile device, desktop computer, or other type of electronic device capable of executing instructions 406-410. The instructions 406-410 may be implemented as methods, functions, operations, and other processes implemented as machine-readable instructions stored on the storage medium 404, which may be non-transitory, such as hardware storage devices (e.g., random access memory (RAM), read only memory (ROM), erasable programmable ROM, electrically erasable ROM, hard drives, and flash memory).

The processing resource 402 may fetch, decode, and execute instructions 406-410 to determine a current domain of a wireless device and in response to the determination that a non-3GPP domain (e.g., WLAN) is the current domain, terminate (i.e., connect) a call to the wireless device in the non-3GPP domain. Specifically, the processing resource 402 executes instructions 406-410 to: in response to an initiation of terminating call, query an enhanced packet data gateway (ePDG) for activity corresponding to the wireless device within the non-3GPP access domain; in response to the query for activity, the computing device 400 receives time information form the ePDG corresponding to the activity of the wireless device within the non-3GPP domain; based on the time information from the ePDG, the call is terminated to the wireless device within that non-3GPP domain.

The machine-readable storage medium 404 includes instructions 406-410 for the processing resource 402 to fetch, decode, and execute. In another embodiment, the machine-readable storage medium 404 may be an electronic, magnetic, optical, memory, storage, flash-drive, or other physical device that contains or stores executable instructions. Thus, the machine-readable storage medium 404 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 404 may include an application and/or firmware which can be utilized independently and/or in conjunction with the processing resource 402 to fetch, decode, and/or execute instructions of the machine-readable storage medium 404. The application and/or firmware may be stored on the machine-readable storage medium 404 and/or stored on another location of the computing device 400.

FIG. 5 is a block diagram of computing device 500 with a processing resource 502 to execute instructions 506-520 within a machine-readable storage medium 004. Specifically, the computing device 500 with the processing resource 502 to query about activity of a wireless device in a non-3GPP domain and in response receive time information regarding the activity of the wireless device. The time information indicates a current domain of the wireless device. Based on the time information, a phone call is terminated to the wireless device in either the 3GPP domain or the non-3GPP domain. Although the computing device 500 includes processing resource 502 and machine-readable storage medium 504, it may also include other components that would be suitable to one skilled in the art. For example, the computing device 500 may include a controller, memory storage, or other suitable type of component. The computing device 500 is an electronic device with the processing resource 502 capable of executing instructions 506-520 and as such embodiments of the computing device 500 include a networking device, server, switch, router, mobile device, desktop computer, laptop, or other type of electronic device capable of executing instructions 506-520. The instructions 506-520 may be implemented as methods, functions, operations, and other processes implemented as machine-readable instructions stored on the storage medium 504, which may be non-transitory, such as hardware storage devices (e.g., random access memory (RAM), read only memory (ROM), erasable programmable ROM, electrically erasable ROM, hard drives, and flash memory).

The processing resource 502 may fetch, decode, and execute instructions 506-520 to terminate a call to a wireless device in a non-3GPP access domain, such as WLAN in response to the current domain of the wireless device being WLAN. Specifically, the processing resource 502 executes instructions 506-520 to: based on initiation of a call termination to a wireless device, query an ePDG for activity of the wireless device in the non-3GPP access domain, such as the WLAN; while querying the ePDG for activity of the wireless device, query a 3GPP access domain (e.g., 2G, 3G, 4G, etc.) for activity of the wireless device; receive time information regarding the wireless device activity from the ePDG and component(s) corresponding to the 3GPP access domain; based on this time information, determine which domain is the current domain of the wireless device; in response to the one of the 3GPP access domains as the current domain, terminate the phone call within the respective 3GPP domain; and in response to the non-3GPP access domain as the current domain, terminate the phone call within the WLAN representing the non-3GPP access domain.

The machine-readable storage medium 504 includes instructions 506-520 for the processing resource 502 to fetch, decode, and execute. In another embodiment, the machine-readable storage medium 504 may be an electronic, magnetic, optical, memory, storage, flash-drive, or other physical device that contains or stores executable instructions. Thus, the machine-readable storage medium 504 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processing resource 502 to fetch, decode, and/or execute instructions of the machine-readable storage medium 504. The application and/or firmware may be stored on the machine-readable storage medium 504 and/or stored on another location of the computing device 500.

Although certain embodiments have been illustrated and described herein, it will be greatly appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a variety of ways. This application is intended to cover adaptions or variations of the embodiments discussed herein. Therefore, it is manifestly intended that embodiments be limited only by the claims and equivalents thereof.

We claim:

1. A method comprising:
in response to an initiation of a call termination, requesting activity of a wireless device in a non-3GPP access domain by an authorization server;
in response to the request, receiving information, by the authorization server, regarding the activity of the wireless device in the non-3GPP access domain;
based on the information regarding the activity of the wireless device in the non-3GPP access domain, performing a determination that the non-3GPP access domain is the current domain;
based on the determination that the non-3GPP access domain is the current domain of the wireless device, terminating the phone call to the wireless device in the non-3GPP access domain.

2. The method of claim 1 wherein based on the determination that the non-3GPP access domain is not the current domain further comprises:
performing the determination that a 3GPP access domain is the current domain of the wireless device; and
based on the determination that the 3GPP access domain is the current domain, terminating the phone call to the wireless device in the 3GPP access domain.

3. The method of claim 1 further comprising:
initiating a request for the activity of the wireless device from the home subscriber server (HSS) to the authorization server.

4. The method of claim 1 wherein requesting activity of the wireless device in the non-3GPP access domain via the authorization server comprises:
transmitting a request to an enhanced packet data gateway (ePDG) of the activity corresponding to the wireless device.

5. The method of claim 1 wherein in response to the request, receiving information by the authorization server, regarding the activity of the wireless device from the non-3GPP access domain comprises:
receiving a time stamp corresponding to the activity of the wireless device from the non-3GPP access domain.

6. The method of claim 1 further comprising:
querying a 3GPP access domain for activity of the wireless device;
determining if the 3GPP access domain is the current domain of the wireless device; and
in response that the non-3GPP access domain is not the current domain and the 3GPP access domain is current domain of the wireless device, terminating the phone call to the wireless device in the 3GPP access domain.

7. The method of claim 1 wherein based on the information from the non-3GPP access domain, performing the determination that the non-3GPP access domain is the current domain comprises:
transmitting a time stamp and a radio access technology (RAT) type corresponding to the wireless device from the authorization server to a home server.

8. A system comprising:
an authorization server comprising:
networking hardware, in communication with an enhanced packet data gateway (ePDG) in a non-3GPP access domain, the networking hardware to:
receive time information corresponding to activity of a wireless device in a wireless local area network (WLAN) from the ePDG;
transmit the time information to a home server for determination that the WLAN is a current domain of the wireless device; and
in response to the determination that the WLAN is the current domain of the wireless device, terminate a phone call to the wireless device in the WLAN.

9. The system of claim 8 comprising:
the ePDG to:
communicate with a wireless access point in the WLAN, the wireless access point in communication with the wireless device; and
transmit the time information to the authorization server based on the activity of the wireless device.

10. The system of claim 8 comprising:
a home server, in communication with the authorization server and a 3GPP access domain, to:
query the authorization server for the time information corresponding to the activity of the wireless device in the WLAN; and
query a 3GPP access domain for activity of the wireless device in the 3GPP access domain;
in response to the activity information from the authorization server and the 3GPP access domain, identify the current domain of the wireless device.

11. A non-transitory machine-readable storage medium comprising instructions that when executed by a processing resource cause an authentication, authorization, and account (AAA) server to:
in response to a call termination, query an enhanced packet data gateway (ePDG) associated with a non-3GPP access domain for an activity of a wireless device in the non-3GPP access domain;
receive time information corresponding to the activity of the wireless device in the non-3GPP access domain from the ePDG; and
based on the time information corresponding to the activity of the wireless device in the non-3GPP access domain, terminate a call to the wireless device in the non-3GPP access domain.

12. The non-transitory machine-readable storage medium of claim 11 comprising instructions that when executed by the processing resource cause the AAA server to:
query a 3GPP access domain for the activity of the wireless device in the 3GPP access domain.

13. The non-transitory machine-readable storage medium of claim 12 comprising instructions that when executed by the processing resource cause the AAA server to:
in response to the time information corresponding to the activity of the wireless device in the non-3GPP access domain and the 3GPP access domain, identify a current domain of the wireless device;
in response to identification of the non-3GPP access domain is the current domain of the wireless device, terminate the call to the wireless device in the non-3GPP access domain.

14. The non-transitory machine-readable storage medium of claim 11 wherein the time information from the ePDG includes a time stamp corresponding to the activity of the wireless access device in the non-3GPP access domain and a radio access technology (RAT) type.

15. The non-transitory machine-readable storage medium of claim 11 comprising instructions that when executed by the processing resource cause the AAA server to:
transmit the time information from the ePDG to a home server for at determination of a current domain of the wireless device.
